(19) United States
(12) Patent Application Publication
(10) Pub. No.: US 2005/0074720 A1
(43) Pub. Date: Apr. 7, 2005

(54) Apparatus for maintaining a dry field during dental procedures

(76) Inventor: Ross William Anderson, Plymouth, MI (US)

Correspondence Address: DORR CARSON SLOAN & BIRNEY, PC, 3010 EAST 6TH AVENUE, DENVER, CO, 80206, US

(21) Appl. No.: 10/994,096

(22) Filed: Nov. 19, 2004

Related U.S. Application Data
(63) Continuation-in-part of application No. 10/301,940, filed on Nov. 22, 2002.

(51) Int. Cl. A61C 17/06

(52) U.S. Cl. 433/136; 433/140; 433/93

(57) ABSTRACT

An apparatus for maintaining a dry field during dental procedures includes a tongue shield for holding the patient's tongue in a retracted position. Cheek distention arms extend laterally outward from the tongue shield to distend the cheek away from the teeth. Optionally, lip retractors extend from the cheek distention arms. Stanchions on the cheek distention arms can be used to removably engage the tip of a saliva ejector and thereby secures the position of the saliva ejector relative to the apparatus and the patient's anatomy.

### RELATED APPLICATION

The present application is a continuation-in-part of the Applicant's co-pending U.S. patent application Ser. No. 10/301,940, entitled “Apparatus for Maintaining a Dry Field During Dental Procedures,” filed on Nov. 22, 2002.

### BACKGROUND OF THE INVENTION

1. Field of the Invention

The present invention relates generally to the field of dental appliances. More specifically, the present invention discloses an apparatus for maintaining a dry field during dental procedures.

2. Statement of the Problem

Throughout the field of dentistry, chairside procedures must be managed to simultaneously achieve a number of objectives. Dentists, orthodontists, prosthodontists, oral surgeons and the like must provide patient comfort while at the same time accomplishing complex therapeutic treatment procedures within the confines of the oral cavity. The clinician must also manage a number of peripheral factors while he or she focuses on achieving worthwhile, long-lasting treatment results. The clinician must strive to minimize such factors as the amount of chair time required to accomplish various treatment goals, the amount of auxiliary staff assistance required as well as overall practice overhead to insure that such professional services remain economically practical for all involved. All of these factors drive dental professionals to embrace improved chairside systems, armamentarium, techniques and procedures that save time, improve results and reduce costs. One aspect of such dental practice economics addressed by the present invention involves those procedures where the polymerization or curing of dental acrylic and various types of dental adhesives must be accomplished. Such procedures typically demand that a dry field be achieved and maintained from the beginning to the end of such procedures. Establishing a dry field involves the isolation of a tooth or a segment a dental arch where tooth surfaces must be cleaned, desiccated., and kept completely dry for the duration of a procedure. In such cases, maintaining dry conditions within the oral environment is essential for the successful, long-term functioning of such cured resins and polymers.

Since tooth enamel and dentin cannot be dissolved by organic solvents, commonly used dental resins and polymers rely on a mechanical bond rather than a chemical bond for adhering such things as orthodontic braces, dental appliances, veneers and sealants, reconstructive prosthesis and composite restorations. Many common bonding procedures involve the preparative step of etching the prepared tooth surfaces with an orthophosphoric or citric acid solution to create a roughened tooth bonding surface. Similarly, it is a common practice to roughen metallic bonding surfaces of various types of dental hardware through a process of vapor abrasion. Vapor abrasion involves directing compressed air carrying micron-sized particles of ceramic carbide or silicon dioxide. Both etching and vapor abrasion prepare the bonding substrates to create greater surface area and greater “purchase” for improved strength and retention of the subsequently-applied adhesive.

Saliva and saliva-borne oral biotica are the nemesis of sound mechanical bonds in that if present, they introduce a release agent of sorts, disrupting the micro inter-articulation of the adhesive with the prepared substrates to be joined. Likewise, for other types of dental polymers such as dental acrylic, moisture serves as an inhibiter of full molecular cross-linking and interferes with the attainment of a complete, amorphous chemical cure throughout the acrylic mass. In such cases where less than complete polymerization is achieved, toxic, unpolymerized monomer may leach into the oral environment. Further, unless a full cure is achieved, such materials do not achieve full strength or full hardness. As can be appreciated, achieving and maintaining a dry field is a critical, yet routine and sequential step required by many types of dental procedures.

As an example of a typical chairside procedure requiring a dry field, U.S. Pat. No. 6,354,833 (Townsend-Hansen) describes the need to maintain dry field conditions while bonding orthodontic brackets to a patient's teeth. The composite resins use for bonding brackets to the exposed tooth surface typically require a completely dry field of operation from start to finish. The enamel is etched at the bond site leaving a roughened surface suitable for resin infiltration. A primer is placed on the etched enamel surface, and the bonding resin is placed on the bracket. The bracket is then positioned on the tooth and allowed to cure chemically or is cured by light irradiation from a dental curing device. In orthodontics, it is well known that saliva contamination of a prepared bonding site will reduce the ultimate strength attained by the cured bonding material and it will significantly increase the likelihood of problematic bracket bond failures during orthodontic treatment.

Saliva is produced in and secreted from the salivary glands. The basic secretory units of salivary glands are clusters of cells called an acini. These cells secrete a fluid that contains water, electrolytes, mucus and enzymes, all of which flow out of the acinus into collecting ducts. Secretion of saliva is under control of the autonomic nervous system, which controls both the volume and type of saliva secreted. The production of saliva is a naturally-occurring continuous process that cannot be temporarily halted or consciously regulated. One aspect then of the many chairside procedures that require a dry field is that the need to evacuate saliva from the mouth is continuous as it collects and puddles in the lower posterior vestibules and under the tongue.

In the dental operatory, the responsibility for removing saliva from a patient's mouth is typically relegated to auxiliary staff personnel, who must periodically manipulate, reposition and activate saliva suction/removal devices. In practice, the actual evacuation of pooled saliva periodically requires a few seconds at each of multiple positions in the mouth. This typical chairside scenario introduces a number of obstacles and limitations for the attending clinician in his or her efforts to achieve treatment-related goals. First, the attending clinician must periodically pause from his or her in-process procedure while saliva is evacuated. This results in an interruption to the clinician's visual and mental focus. The very presence of a second person at chairside alters the ergonomics of the dental operatory and restricts space and free movement. The auxiliary staff member must move their hands in and around the oral cavity to evacuate saliva, again breaking the clinician's field of view, as well as mental focus. The cost associated with the presence of an auxiliary staff member, as well as the cumulative increase in time required for saliva evacuation all combine to increase the overhead costs for the practice, which increases the ultimate cost of treatment. For all of these reasons, the value of improved dry field-related devices and methods can be appreciated and for all of these reasons, improved devices and methods for the removal of saliva have been sought.

In addition to the challenges of saliva control, another fundamental challenge faced by clinicians involves the increased difficulty of performing procedures in the posterior region of the oral cavity. The central problem associated with delivering dental treatment in this region of the mouth is the general restriction of space as well as reduced physical and visual access. The posterior regions of the mouth are inherently darker and less accessible and it is more difficult to direct light where needed. The adjacent bony structures of the anterior aspect of the ramus, and the soft tissue and musculature of the cheeks restrict the clinician's access and prevent a direct or perpendicular line of sight. The confined vestibular space between the buccal surfaces of the posterior teeth and the adjacent soft tissues of the cheeks limits the number and size of dental instruments that can occupy the space, and makes the transportation of dental materials and dental armamentarium in and out of the mouth more difficult.

Yet another challenge routinely faced by the clinician is the interference and unpredictability posed by a free and unruly tongue. Patients typically have little positional awareness of their tongue during treatment, and wide and unpredictable tongue movements can suddenly interfere with the clinician's efforts and focus, and a wandering tongue can potentially contaminate dry field conditions.

### PRIOR ART

The prior art in the field of dentistry and orthodontics includes a wide variety of tongue retractors and devices for extracting saliva, including the following:

| Inventor | Pat. No. | Issue Date |
|---|---|---|
| Confresi | 3,049,806 | Aug. 21, 1962 |
| Reichley | 4,215,984 | Aug. 5, 1980 |
| Nelson | 4,259,067 | Mar. 31, 1981 |
| O'Neil | 4,260,378 | Apr. 7, 1981 |
| Diamond | 4,511,329 | Apr. 16, 1985 |
| Dyfvermark | 4,975,057 | Dec. 4, 1990 |
| Hickham | 5,037,298 | Aug. 6, 1991 |
| Duggan et al. | 5,152,686 | Oct. 6, 1992 |
| Anderson | 5,460,524 | Oct. 24, 1995 |

“DentaPops”, New Line Medical—Dental and Medical Products, http://www.newlinemedical.com/DentaPops.html

Anderson discloses a device and method for saliva suction in dental procedures that includes a tongue retractor and bite handle. The embodiment shown in FIG. 12 of the Anderson patent includes a retraction wing or cheek retractor. This device engages the tubing in a manner that directs the suction tubing outward and in contact with the cheeks, thus holding the cheeks away from the teeth.

Confresi discloses a device for suctioning saliva from the oral cavity including a tubular member having inlet orifices on both sides of the teeth and an adjustable brace serving as a tongue depressor.

Reichley discloses a dental suction device having a U-shaped base designed to be positioned on the patient's lower teeth.

Nelson discloses a dental device for isolating a region of the mouth, and includes a frame to retain the device and a shield member to retract the tongue from the lower teeth.

O'Neil discloses a self-stabilizing intra-oral saliva evacuator.

Diamond discloses a moisture-controlling lingual dental mirror.

Dyfvermark discloses a bite block appliance with an aperture serving as an evacuation nozzle for saliva suction.

Hickham discloses an apparatus for ejecting saliva that includes a pair of saliva ejectors connected to a tongue retractor, a cheek retractor connected to a tongue retractor, and a cheek retractor connected to a tongue retainer that is secured to the tongue retractor.

Duggan et al. disclose an appliance for suctioning debris from the oral cavity that includes a tongue stabilizer and a removable suction tube secured to a bite block.

The “DentaPops” internet web site discloses a disposable device resembling a candy sucker having a hollow stem for evacuating saliva.

### SOLUTION TO THE PROBLEM

The present invention brings forth a multi-function device that is designed to control, and continuously remove saliva from the mouth without the need for manipulation. It is intended to be used in conjunction with conventional chairside saliva evacuation systems, and is intended to act continuously, thus greatly reducing or eliminating the need for monitoring and manipulation of saliva evacuation equipment. In particular, the cheek distention arms of the device are equipped with stanchions that removably engage the tip of a standard saliva ejector tube and thereby secure the suction ejector in a desired position. In addition, the tongue shield and optional bite block control the tongue, and create space in, and access to the posterior regions of the mouth.

### SUMMARY OF THE INVENTION

This invention provides an apparatus for maintaining a dry field during dental procedures. A tongue shield holds the patient's tongue in a retracted position. Cheek distention arms extend laterally outward from the tongue shield to distend the cheek away from the teeth. Optionally, lip retractors extend from the cheek distention arms. Stanchions on the cheek distention arms can be used to removably engage the tip of a saliva ejector and thereby secures the position of the saliva ejector relative to the apparatus and the patient's anatomy.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a top perspective view of the present device 30.

FIG. 2 is a bottom perspective view of the present device 30.

FIG. 3 is a perspective view of the device 30 in place over a patient's lower teeth.

FIG. 4 is a perspective view corresponding to FIG. 3 showing the device 30 in place over a patient's lower teeth with the tip 22 of a saliva ejector 20 attached to a stanchion 37.

FIG. 5 is a bottom view of the device 30 with the tip 22 of a saliva ejector 20 attached to a stanchion 37.

FIG. 6 is a perspective view corresponding to FIG. 3 showing the device 30 in place over a patient's lower teeth with a saliva ejector 20 held in a notch 34 in the tongue shield 33.

FIG. 7 is a perspective view of the present device 30 with a bite block 40

FIG. 8 is a front perspective view of an embodiment of the present device with lip retractors 50.

FIG. 9 is a rear perspective view of the embodiment shown in FIG. 8.

FIG. 10 is a rear view of the embodiment shown in FIG. 8.

FIG. 11 is a front view of the embodiment shown in FIG. 8.

FIG. 12 is a front view of the embodiment of FIG. 8 in a patient's mouth.

FIG. 13 is a front view corresponding to FIG. 12 with saliva ejectors 20 attached to the present device 30.

FIG. 14 is a front perspective view corresponding to FIG. 8 with saliva ejectors 20 attached to the present device 30.

### DETAILED DESCRIPTION OF THE INVENTION

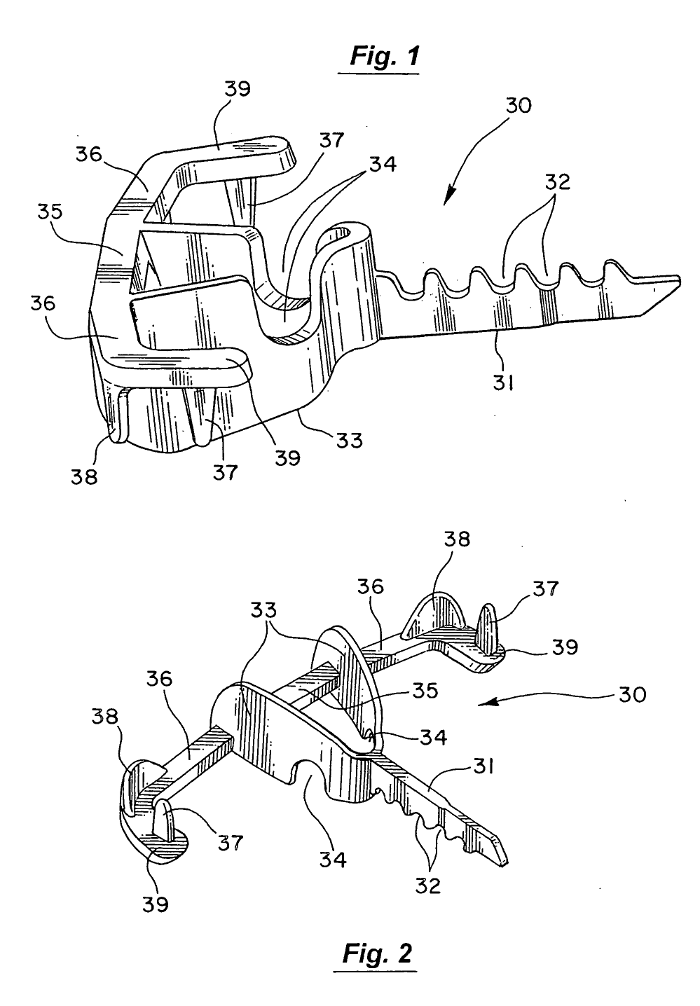

The present invention is a one-piece, preferably injection molded plastic appliance 30 that is meant to be positioned in the mouth of a patient undergoing a procedure that requires the maintenance of a dry field, or involves procedures in the posterior area for the mouth. A bite handle 31 extends forward from the front of the appliance 30 as shown in the top and bottom perspective views of the appliance 30 depicted in FIGS. 1 and 2. On the top surface of the bite handle 31 are positioning notches 32 of a generally saw-tooth configuration. The saw-tooth configuration consists of a series of identical notches 32, each having a mesial side and distal side and a notch floor. The sides are at predetermined angles relative to the long axis of the bite handle 31 and as such, are optimized to function for optimal mesio-distal stabilizing of the device in the mouth through engagement with a patient's upper and lower central incisor teeth.

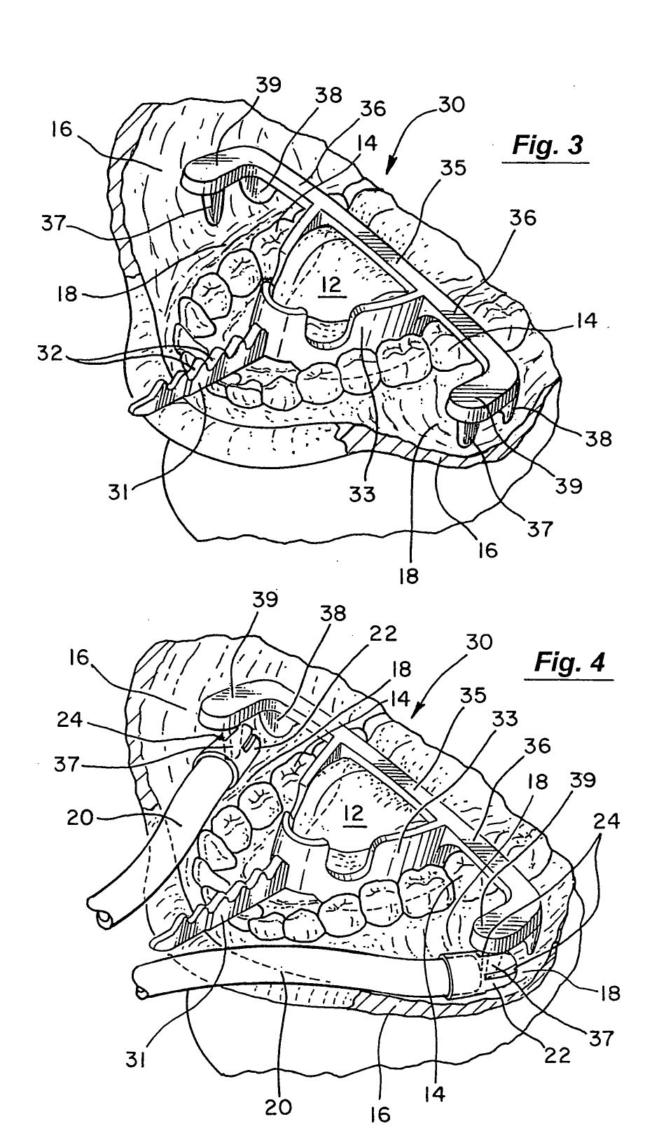

In use, the bite handle 31 is gripped by the clinician or staff member by thumb and forefinger pressure and positioned within the patient's mouth in the most rearward position that a patient can comfortably tolerate. Due to the careful sizing of the appliance 30 in terms of its overall width in the preferred embodiment of the present invention, the appliance 30 must be rotated left/right about a vertical axis past the patient's lips and then moved distally into position. As the device 30 is gently pushed distally, a generally U-shaped tongue shield 33 corrals the tongue 12 and desirably restrains the tongue 12 to a rearward position as shown in FIG. 3. The patient is then instructed to bite down on the bite handle 31 and to thereafter maintain gentle closing pressure on the bite handle 31. In doing so, the patient's upper central teeth will naturally fall into registration with one or another of the positioning notches 32, depending on the patient's age and size. As the device 30 is positioned in this manner, the entire device will inherently be centered laterally, and mechanically held in a most posterior position in the patient's mouth. Through positioning and holding the tongue 12 in such a retracted position, it is least likely to pose problems and introduce interruptions during a procedure, and it is least likely to inadvertently contaminate dry field conditions.

As can be seen in FIGS. 1 and 2, the bite handle 31 exhibits multiple lateral thicknesses. As shown, the reduced thickness of the handle 31 at its forward-most end provides a thinner section compared to a thicker distal cross-section. The thinner section provides an ideal ergonomic grip for the thumb and forefinger, while at the same time providing a slightly reduced obstruction for the clinician's labially-directed field of view. The thicker more distal sections provide structural integrity and stiffness, and as such does not restrict the clinician's line of sight due to parallax. The transition point from a thinner section to a thicker section provides a mechanical stop of sorts for the thumb and forefinger thus aiding the doctor or staff in urging the device 30 as far distally as can be comfortably tolerated by a patient.

The positioning notches 32 as shown in the drawings are located on the upper surface of the bite handle 31. As can be appreciated, the positioning notches 32 can function in an identical manner, and equally as effectively if located on the lower surface of the bite handle 31. When located on the lower surface, the top surface of the bite handle 31 can remain smooth and straight. Alternatively, positioning notches 32 could be provided on both the upper and lower surfaces of the bite handle 31.

As shown in FIG. 1, a cross bar 35 extends across the rear of the tongue shield 33 adjacent to the patient's molars and above the tongue. This cross bar 35 serves several functions: First, as can be appreciated, the cross bar 35 spans the top of the tongue 12 when the device 30 is positioned in the mouth. In doing so, it functions to further restrain the tongue 12 from significant upward movement. As the cross bar 35 holds the tongue 12 down in this manner, it tends to gently compress the tongue 12 as it passes over it thus forming a shallow trough of sorts in the tongue 12. Such a trough in the tongue 12 serves as a transverse-extending aqueduct of sorts where saliva can collect. Saliva can then flow laterally to points in between the tongue shield 33 and the left and right sides of the tongue 12. As will be described below, the appliance 30 incorporates means for the evacuation of saliva collected from the trough formed by the cross bar 35. The cross bar 35 also acts as a structural member preventing the tongue shield 33 from flexing laterally in use and generally absorbs such stresses, thereby removing some flexural loads on the more forward portions of the tongue shield 33. This allows the tongue shield 33 to be formed thinner in cross-section.

As can be seen in FIG. 3, the device 30 has left and right laterally-extending cheek distention arms 36 that extend outward in opposite directions from the rear portions of the tongue shield 33. In the preferred embodiment of the present invention, the arms 36 are structurally contiguous with the cross bar 35. The cross bar 35 serves to stabilize the laterally-extending arms 36, again sheltering the tongue shield 33 from bending loads and torsional forces transmitted from the left and right arms 36. Again, this permits the tongue shield 33 to be designed with a thinner cross-section.

As the reader can appreciate, the improved features of the present inventive device address one clinical problem described above which involves restraining the tongue 12 in a most rearward position and further acts to prevent upward movement of the tongue 12. Another problem faced by clinicians as described above is the general increased difficulty associated with treatment procedures in the posterior sections of the mouth due to constricted space, limited access and an obstructed line of sight. The present invention generally addresses these problems by providing structure for holding the patient's cheeks 16 well away from the posterior teeth 14 and thus creating a volume of open working space at each side of the mouth, thereby generally improving access to the rear portions of the mouth.

In the preferred embodiment of the present invention, the overall width of the device 30, including the cheek distention arms 36, is maximized so that only through such sequential, rotating and gentle stretching steps can the device 30 be inserted. Importantly, the overall width of the posterior end of the tongue shield 33 is considered and then the lengths of the cheek distention arms 36 are ergonomically maximized so that the rotating, sequential insertion steps require the patient's lips to be stretched to a comfortable maximum. In this sense then, the overall width of the device is designed to be as wide as possible for insertion.

In the broadest sense, all dental procedures can be conceptually divided into two groups: adult procedures, and toddler/infant/adolescent procedures. Adult procedures involve general dental care, prosthetic and reconstructive procedures and others. Procedures directed to the toddler/infant/adolescent group involve pedodontic and orthodontic treatment and other procedures. As can be appreciated, the device of the present invention can be formed in multiple sizes, and each size can be thought of as being as wide as possible for the respective patient population in each group. The present invention can be optimized in this manner for maximum ideal width for any patient age/size population and provides the advantage of holding a patient's cheeks outward to a maximum-possible extent permitted by the patient's lip musculature.

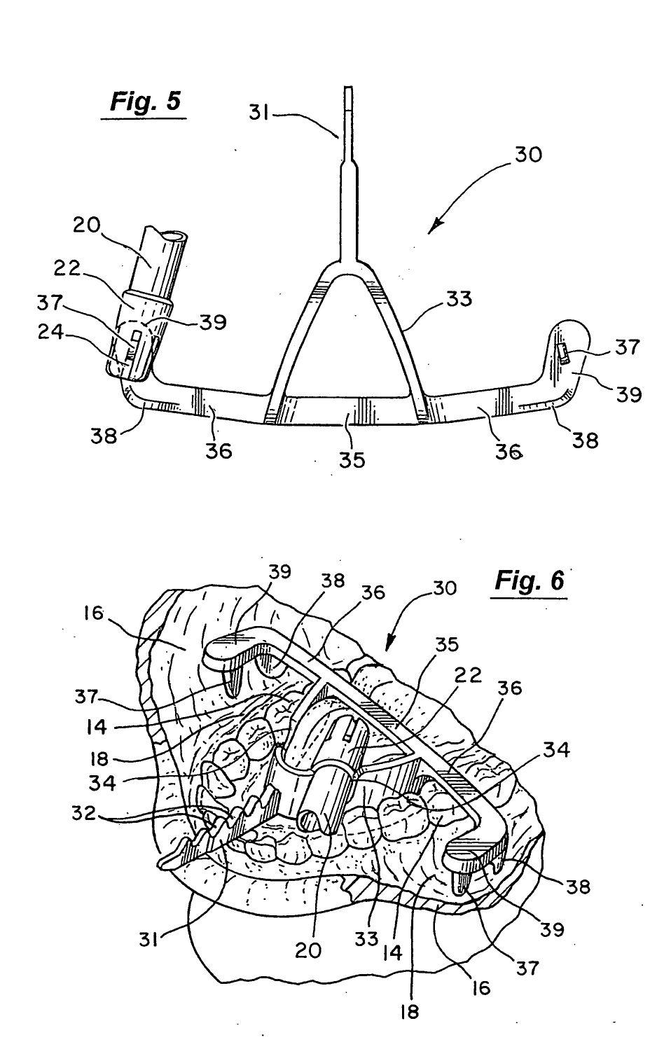

In addition to being maximized for overall width, the right and left arms 36 also include a soft tissue shield 38 at the outer-most extent of the arms 36. As shown in FIGS. 2 and 5, the soft tissue shield 38 extends downward from the rear of the outermost extent of the cheek retention arm 36. It is optimized to provide a wall between the clinicians working area and the soft tissue and musculature located at the posterior extent of the lower vestibule 18 (i.e., the pocket formed between the patient's molars 14 and cheek 16). Its lower extent, and all of its edges are optimized to retract soft tissue without compromising patient comfort. The extent to which the soft tissue shield 38 extends downward from the arm 36 is important to the functioning of other features to be described.

At the outer extent of both arms 36, a kidney-shaped horizontal pad is formed, referred to hereafter as the cheek distention finger 39. Both left and right cheek distention fingers 39, as well as their somewhat outwardly-angled orientation can be seen in FIG. 2 and 5. The cheek distention fingers 39 are formed in an optimal biologically-compatible shape to accommodate insertion as described above. Once in position and while in use, the left and right cheek distention fingers 39, along with the left and right soft tissue shields 38 all act together to hold the cheeks 16 outward and backward to the greatest possible extent.

As can be appreciated, in use, the resulting inwardly-directed pressures of the retracted cheeks and associated musculature can be significant. The cross-section profile of the arms 36 and their associated structures are configured to exhibit an adequate cross-section to structurally accommodate such loads, and are further intended to flex and comply somewhat under such loads without significant bending. For safety, the device is formed from materials know to fail in a non-catastrophic mode. Polyethylene, polypropylene, polysulphone and other moderately soft and moderately ductile plastics are known to be biocompatible, pliable, and exhibit mechanical properties that will not yield or fail catastrophically. A brittle plastic could otherwise snap under heavy contraction of the facial musculature, producing sharp failed ends that could lacerate the soft tissues of the mouth.

Considering the group of commercially-available bioengineering plastics from which devices of the present invention could be formed, some have non-catastrophic failure characteristics and can tolerate heat sterilization without degradation, but are expensive. Other plastics are inexpensive but cannot survive the temperatures associated with sterilization. Given this range of material properties, the present invention is envisioned as being available in inexpensive disposable versions that are discarded after a single use as well as sterilizable versions that could be used repeatedly.

In addition to the soft tissue shields 38 and the cheek distention fingers 39, other features located at the outer ends of the arms include stanchions 37 intended to inter-work with standard saliva ejector tubes 20. Known more commonly as saliva ejectors, they are a commodity-type dental supply item available from many dental supply sources. Saliva ejectors 20 are sized to accommodate standard operatory suction tubing, which is in turn connected to a central remote vacuum pump. The operatory suction tubing can employ a Y-shaped fitting so that multiple saliva ejectors can be simultaneously used during a patient's treatment if needed. Standard saliva ejectors exhibit a hollow tube portion and an interconnected hollow head 22. The tubing portion consists of a pliable plastic tube. A compliant, ductile metallic wire is embedded within the walls of the plastic tubing. When the tubing is bent or adapted as needed in use, the embedded wire likewise bends and tends to allow the tubing to take on and retain any gentle shape that a staff member may form in the tubing. For example, the saliva ejector may be shaped similar to a question mark to allow it to simply hang from a patient's lower lip with the head located in the mouth.

The head 22 of the saliva ejector 20 is formed from a somewhat harder plastic than the ductile plastic/metallic wire tubing section. The tubing section and the head 22 are structurally joined to form a single unit. The head 22 exhibits multiple slits 24, which open into the hollow interior. In use, the lower air pressure produced by a central vacuum pump, which is conveyed through the tubing causes air to be drawn into the saliva evacuator head 22 through its multiple slits 24 located circumferentially around its exterior. In use, when the head 22 of the saliva ejector 20 is placed in a pool of saliva, the lower pressure within the interior of the head 22 picks up saliva, which is then drawn out of the mouth and away from the patient through the system of suction tubing.

The present invention has blade-shaped stanchions 37 that extend downward from the cheek distention arms 36 to removably engage the head 22 of a standard saliva evacuator 20, as illustrated in FIGS. 4 and 5. Once engaged, the present device 30, in conjunction with a standard saliva ejector 20 provides the benefit of continuous saliva evacuation.

As can be seen in FIGS. 1-3, a stanchion 37 extends downward from the lower surface of both the right and left cheek distention arms 36. The exterior surfaces of the stanchions 37 are generally blade-shaped and exhibit a very gentle taper. The tip of the stanchion 37 is both rounded from the lateral view and thinner from the mesio-distal perspective. From the mesio-distal perspective, the cross-section thickness of the stanchion 37 tapers to a thicker cross-section at points closer to the cheek distention finger 39. In the preferred embodiment of the present invention, the taper of the stanchions 37 permit frictionally-produced lodging of a stanchion 37 into a slit 24 of any commercially-available saliva evacuator 20, as shown for example in FIG. 4. For example, one particular saliva ejector 20 may have narrower slits than other competitive devices and as such, as the head 22 is forcibly pushed onto a stanchion 37, a frictional interfit there between may be achieved at a point closer to the tip of the stanchion 37. Another commercially available saliva ejector may exhibit wider slits and as such, frictional binding between the stanchion 37 and the head 22 may occur at a point closer to the under surface of the cheek distention finger 39. The stanchion 37 is thus configured to frictionally engage a wide range of slit widths present in the array of commercially available saliva ejectors.

In this manner, the clinician or an auxiliary staff member may attach one saliva ejector unilaterally or multiple saliva ejectors bilaterally to the current invention prior to placement in the mouth, or the saliva ejectors may be attached after insertion the present inventive device in the mouth. Due to the gentle taper of the stanchions 37 and the resulting nature of the frictional inter-fit with slits 24, a saliva ejector may be readily removed from and readily replaced on a stanchion 37 as needed during a dental procedure.

Alternatively, other means can be employed to enable the stanchion 37 to removably engage the head 22 of a saliva ejector 20 in place of, or in addition to frictional contact. For example, the stanchion 37 could be equipped with a connector or fastener (e.g., hook-and-loop material, a clasp mechanism, a hook-and-eye fastener, adhesive, a magnet, a clip, or a snap fastener) for attachment to the saliva ejector 20. The saliva ejector can also be equipped with a complementary connector or fastener, either as an integral part of the saliva ejector or as an attachment.

The downward extent of the soft tissue shield 38 described above is involved in the ideal functioning of the stanchion/saliva evacuator system. The lowest extent of the soft tissue shield 38 pushes soft tissue of the lower posterior vestibule 18 (i.e., the space between the patient's molars 14 and cheek 16) downward to form a saliva collection point. This combined with a patient's normal recumbent position in a dental chair combine to form an effective collection point for saliva excreted from the cheek-located salivary glands. As can be seen above, such a pooling point is located in direct and ideal proximity to the head 22 of the saliva ejector 20 as positioned by the stanchion 37. The soft tissue shield 38 and the cheek distention fingers 39 work together to physically hold soft tissue away from the stanchion 27 and saliva ejector head 22 in a manner that prevents soft tissue from contacting the saliva ejector head 22 and possibly causing it to become dislodged from the stanchion 37.

As viewed from below, the long axis of the stanchions 37 is oriented at an angle relative to the centerline symmetry of the appliance 30. Since the tubing portion of a saliva ejector 20 must enter the mouth at the right-most or left-most extent of a patient's lips, the stanchions 37 are oriented at an angle consistent with aligning the tubing for such entry. As described, the tubing portion of saliva ejectors 20 are adjustably compliant and as such, the saliva ejectors 20 can be adapted to variations in the width between the left-most and right-most points of the lips.

Saliva ejectors 20 may be connected to the present invention in other useful ways and in other useful positions and combinations. As seen in FIG. 6, suction tube notches 34 formed on each side of the tongue shield portion 33 can accept the placement of a saliva ejector 20. Rather than engaging stanchions 37, saliva evacuators 20 engaging the tongue shield 33 rely on a mechanical interfit between a notch 34 of a pre-determined width and the tubing portion of a saliva ejector 20. The left and right suction tube notches 34 formed in the tongue shield 33 are wider than the diameter of typical saliva ejector tubing allowing it to enter the interior area of the tongue shield 33 at an angle slightly more divergent than the natural angle defined as the tubing enters the mouth from a right-most or left-most point of the patient's lips. Such sizing of the suction tube notches 34 provides adequate mechanical binding to hold a saliva ejector 20 in place. Saliva gathered in a trough formed by the cross bar 35, as described previously can also be evacuated with saliva ejectors 20 positioned in this manner.

As can be appreciated, a dental professional, if operating on the left side of the mouth may for example place one saliva ejector 20 on the left stanchion 37. That saliva ejector 20 may then be quickly and without difficulty moved to the right side should the clinician then perform the same procedure on the right side. Other types of procedures may require the simultaneous usage of saliva ejectors 20 on both sides as shown in FIG. 4. Yet another procedure may require that a saliva ejector 20 be lodged in the notches 34 of the tongue shield 33 as shown in FIG. 6. In this manner, saliva ejectors 20 can be employed in several positions and combinations, and then easily changed as a dental procedure progresses as needed.

It should also be understood that the saliva ejector 20 does not necessarily need to be attached to the stanchion 37. For example, the tip of the saliva ejector 20 can simply be placed adjacent to the stanchion 37, tongue shield 33, soft tissue shield 38, check distention arm 36, or cheek distention finger 39. In particular, the tip of the saliva ejector can be placed in the patient's vestibule outboard of the stanchion 37.

At all points on the device, all edges and corners enjoy extensive radiusing and rounding allowing the device 30 to sit comfortably within a patient's mouth without pressure points or any pinching of the patient's tongue, lips or cheeks.

Throughout all of the foregoing the present device 30 has been described as being positioned in the patent's mouth with the upper central anterior teeth engaging the positioning notches 32 of the bite handle 31 and the lower anterior tooth engaging the lower surface of the bite handle 31. As can be appreciated, such a configuration is ideal for dental procedures that involve the buccal surfaces of the posterior teeth. The bonding of orthodontic buccal tubes is an example of a common “teeth-closed” procedure. With the anterior teeth engaging the bite handle 31 however, those procedures that are directed to the occlusal surfaces of the teeth are precluded by the configuration described due to the nearly closed position of the dental arches. The prophylactic application of caries-preventing sealants, the preparation of teeth for restorations, the bonding of prosthetic devices and the seating of pedodontic and orthodontic bands are examples of procedures that both require a dry field and require that the mouth be significantly opened.

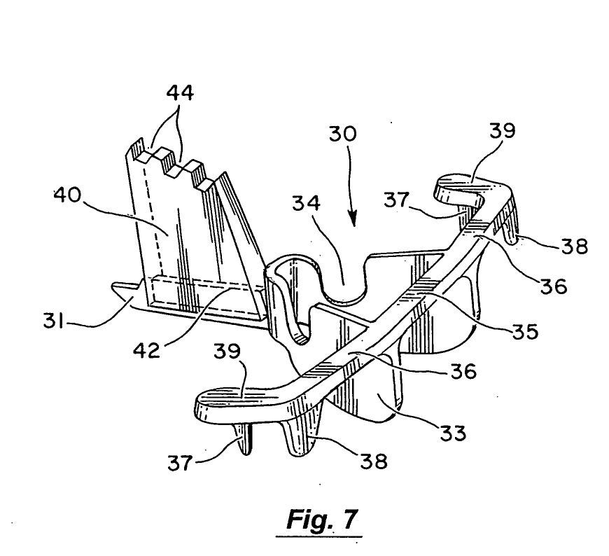

In order for the device 30 to accomplish its intended functions of controlling saliva, retracting the tongue, and retracting the cheeks for mouth-open procedures, an anterior, auxiliary bite block 40 can be used in conjunction with the present device 30 as shown in FIG. 7. The anterior bite block 40 is matingly and slidably positioned on the top surface of the bite handle 31 of the device 30 to maintain a desired minimum spacing between the patient's upper and lower teeth. As depicted in FIG. 1, the device 30 is shown with the positioning notches 32 located on the top surface of the bite handle 31. However, for use with the anterior bite block 40, the notches 32 are preferably located on the bottom surface of the bite handle 31.

As can be understood, when the device 30 is used for closed-mouth procedures, its posterior end is stabilized against upward movement caused by the upward forces of the tongue 12 acting on the cross bar 35 by the left and right arms 36 as they pass between and through the nearly-closed posterior teeth 14. When the device 30 is employed during open-mouth procedures, the posterior teeth 14 no longer act to restrain the left and right arms 36 downward and as such the distal portions of the device 30 may be lifted upward by the tongue 12.

In order to prevent the distal portions of the device 30 from lifting when used in open-mouth procedures, the base of the anterior bite block 40 is wide in its mesial-distal extent and a recess 42 extends along the base of the bite block 40 that positions it over the bite handle 31, as shown in FIG. 7. The compressive forces of the anterior central teeth, acting through the anterior bite block 40, as the anterior bite block is positioned on the bite handle 31 act to hold the device 30 level in the mouth through a downward cantilever force directed through the bite handle 31.

The top surface of the anterior bite block 40 employs multiple positioning notches 44 for engagement with the patient's maxillary central incisors. The top surface of the anterior bite block 40 also slants downward at its distal extent. These features in combination accommodate the anatomy of larger or smaller patients allowing both large and small patients to remain opened at generally the same angle regardless of which positioning notch 44 the upper incisors naturally register in. The anterior bite block 40 is intended to be formed from the same materials as the remainder of the device 30, and may be similarly sterilizable or disposable.

Other types of bite blocks can be used in conjunction with the device 30 to accomplish its intended function of controlling saliva, retracting the tongue, and retracting the cheeks for open mouth procedures. For example, one or more posterior bite blocks can be used to maintain a desired minimum spacing between the patient's upper and lower teeth. Just as the anterior bite block 40 exhibits a recess 42 for engaging the top surface of the bite handle 31, a posterior bite block may exhibit a similar recess configured to engage the top edge of the tongue shield 33 or cheek distention arm 36. Such posterior bite blocks would act similarly to the anterior bite block, but would typically be placed bilaterally on each side of the posterior segment of the dental arches, rather than at a central anterior location as discussed above. Once engaged on the top edge of the tongue shield 33 or cheek distention arm 36, each posterior bite block would stand in mechanical opposition between the upper and lower molars, thus maintaining a desired minimum spacing between a patient's upper and lower teeth. The posterior bite blocks also tend to hold the device 30 in its desired position distally due to the engagement of the posterior bite blocks against the top edges of both sides of the tongue shield 33 or cheek distention arms 36. The distal-holding capability of the posterior bite blocks can be further augmented by notches similar to the positioning notches 44 of the anterior bite block. These notches engage the multiple projecting cusps of the upper and lower first molars or the second molars.

The present device 30 can also be used in conjunction with standard lip retractor devices. For example, lip retractors can be installed over the patient's lips before the device is inserted and distally positioned in a patient's mouth.

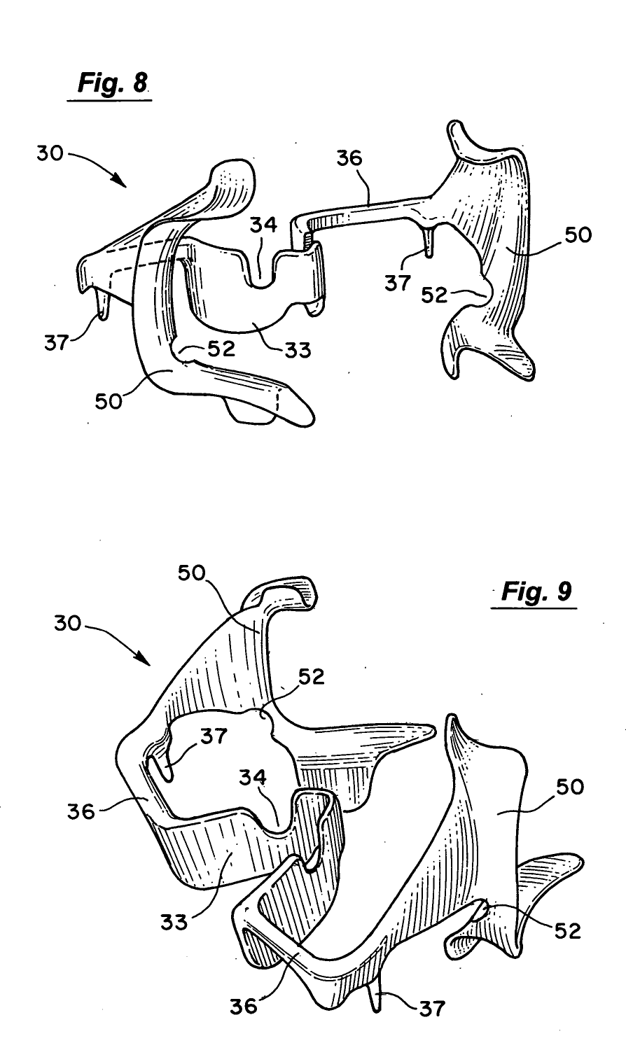

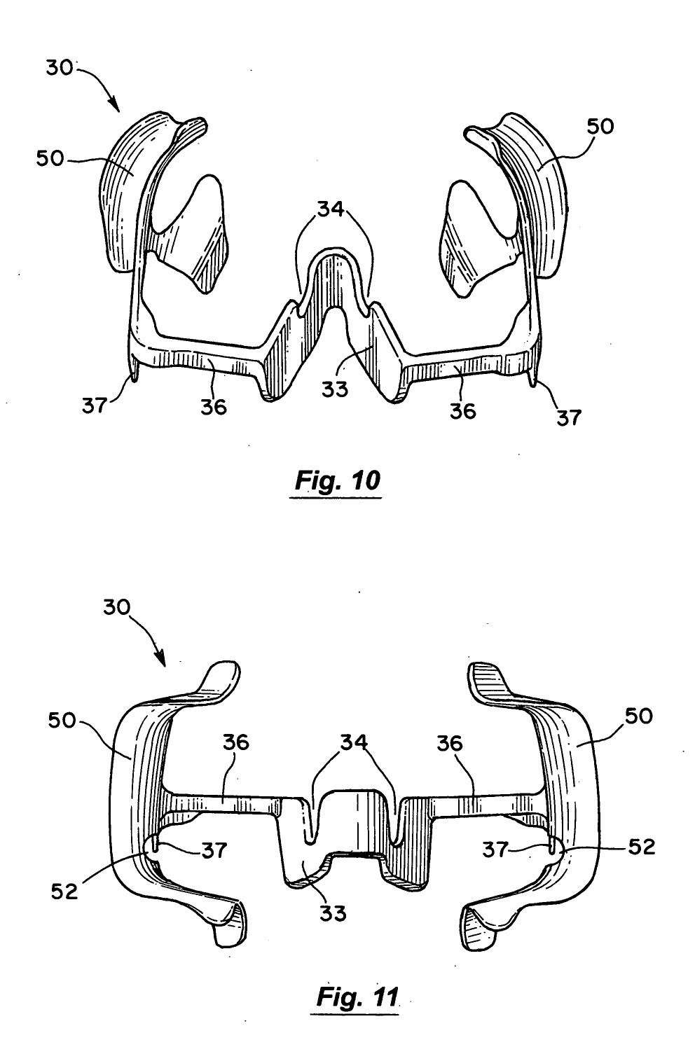

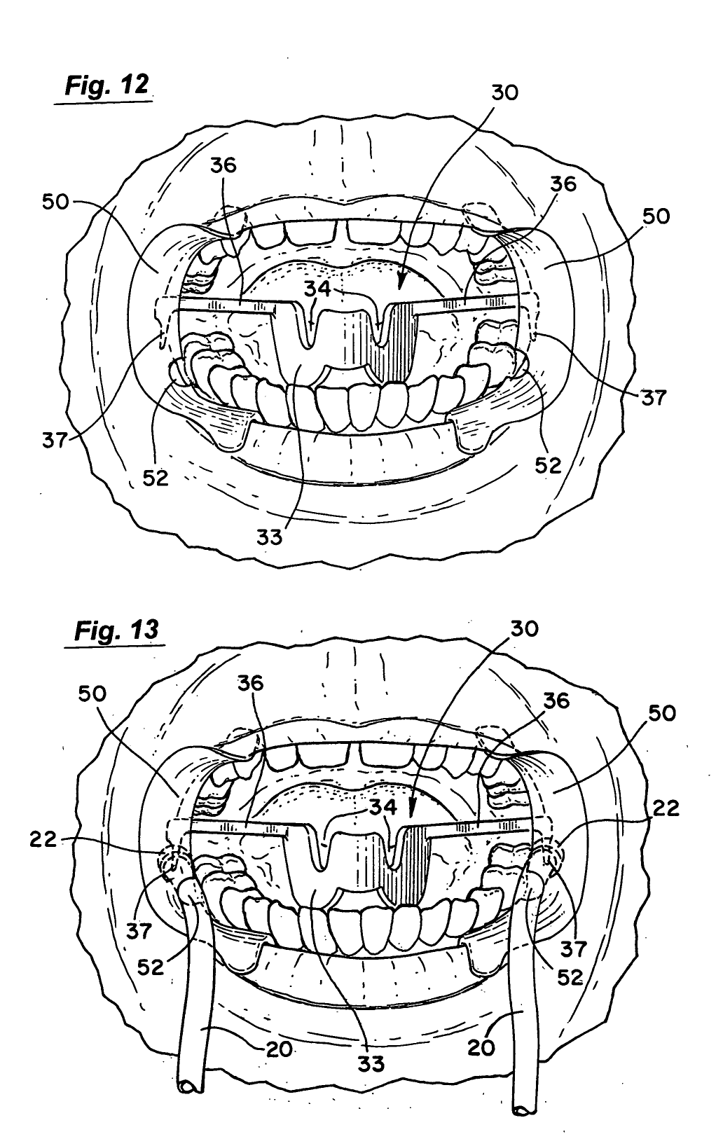

FIGS. 8 through 14 illustrate another embodiment of the present invention that includes lip retractors 50 as an integral part of the dental appliance 30. FIGS. 8 and 9 show front and rear perspective views, respectively, of this embodiment. FIGS. 10 and 11 are corresponding rear and front views, respectively. Two lip retractors 50 extend forward from the cheek distention arms 36. The forward portions of the lip retractors 50 are contoured to retract the patient's lips outward and rearward, and thereby maintain the patient's mouth in an open position to maximize the clinician's field of view. The rearward forces exerted by the lip retractors 50 are countered by forward pressure exerted by the tongue shield 33 on the lingual side of the patient's lower arch. The U-shaped tongue shield 33 also tends to keep the appliance 30 laterally centered within the patient's lower arch. This dynamic balance tends to hold the appliance 30 in place in the proper position in the patient's mouth. FIG. 12 is a front view of the appliance 30 a patient's mouth. It should be noted that the bite handle 40 shown in the previous embodiment becomes unnecessary, and has been omitted in this embodiment.

The dental appliance 30 can be molded from plastic as a single piece, for example. However, it may be simpler to fabricate the appliance in several pieces and then bond or otherwise assemble the pieces together to form the final dental appliance. In particular, the lip retractors 50 has a rather complex shape that may require separate molds.

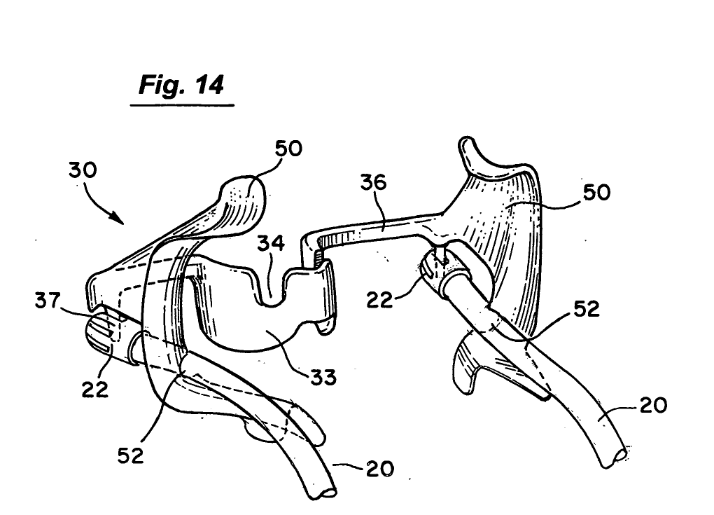

After the appliance 30 has been inserted into the patient's mouth and the lips have been retracted, a saliva ejector 20 can be attached to the stanchions 37 on either or both sides of the appliance, as needed. As previously discussed, the stanchions 37 extend downward from the cheek distention arms 36 and can be used to removably engage the head 22 of a standard saliva ejector 20, as illustrated in FIG. 14.

FIG. 13 is a front view corresponding to FIG. 12 with saliva ejectors 20 attached to the stanchions 37. The lip retractors 50 can be equipped with notches 52 or openings to allow passage of the saliva ejectors 20 without further distension of the patient's lips. These notches further serve to support the saliva ejector 20 in a desired locations relative to the appliance 30 and the patient's anatomy.

The above disclosure sets forth a number of embodiments of the present invention. Other arrangements or embodiments, not precisely set forth, could be practiced under the teachings of the present invention and as set forth in the following claims.

1. An apparatus for maintaining a dry field in a portion of a patient's mouth in conjunction with a saliva ejector having a tip with a number of openings, said apparatus comprising:
a tongue shield for holding a patient's tongue in a retracted position;
cheek distention arms extending laterally outward from opposing sides of the tongue shield to distend a patient's cheeks away from a patient's teeth;
at least one stanchion on a cheek distention arm, wherein a tip of a saliva ejector can be removably secured to a stanchion; and
lip retractors extending from the check distention arms.

2. The apparatus of claim 1 wherein the tongue shield is substantially U-shaped.

3. The apparatus of claim 1 wherein the stanchion removably engages at least one opening in a tip of a saliva ejector.

4. The apparatus of claim 1 wherein the cheek distention arm extends outward from a rear portion of the tongue shield.

5. The apparatus of claim 1 further comprising at least one of notch in a lip retractor for supporting a saliva ejector in a desired location.

6. The apparatus of claim 1 wherein the stanchion extends downward from the cheek distention arms.

7. The apparatus of claim 1 wherein the stanchion has a blade shape.

8. An apparatus for maintaining a dry field in a portion of a patient's mouth in conjunction with a saliva ejector having a tip with a number of openings, said apparatus comprising:
a tongue shield for holding a patient's tongue in a retracted position;
cheek distention arms extending laterally outward from opposing sides of the tongue shield adjacent to a patient's molars to distend a patient's cheeks away from the patient's molars;
lip retractors extending from the check distention arms; and
at least one stanchion extending downwardly from a cheek distention arm, wherein a tip of a saliva ejector can be removably engaged by the stanchion to removably secure a tip of a saliva ejector in a patient's vestibule between the molars and cheek.

9. The apparatus of claim 8 wherein the stanchion removably engages at least one opening in a tip of a saliva ejector.

10. The apparatus of claim 8 wherein the tongue shield is substantially U-shaped.

11. The apparatus of claim 8 further comprising at least one notch in a lip retractor for supporting a saliva ejector in a desired location.

12. The apparatus of claim 8 wherein the stanchion has a blade shape.

13. An apparatus for maintaining a dry field in a portion of a patient's mouth in conjunction with a saliva ejector having a tip with a number of elongated openings, said apparatus comprising:
a U-shaped tongue shield for holding a patient's tongue in a retracted position;
cheek distention arms extending laterally outward from opposing sides of the tongue shield adjacent to a patient's molars to distend a patient's cheeks away from the molars;
at least one blade-shaped stanchion extending downward from a cheek distention arm, wherein the stanchion can be removably secured to an opening in a tip of a saliva ejector to removably secure a tip of a saliva ejector in a patient's vestibule between the molars and cheek; and
lip retractors extending from the check distention arms.

14. The apparatus of claim 13 wherein the stanchion extends downward from the cheek distention arm for holding a tip of a saliva ejector in a patient's vestibule between the molars and cheek.

15. The apparatus of claim 13 further comprising at least one notch in a lip retractor for supporting a saliva ejector in a desired location.
